(19) United States
(12) Patent Application Publication
(10) Pub. No.: US 2010/0091315 A1
(43) Pub. Date: Apr. 15, 2010

(54) Image forming apparatus

(75) Inventor: Takamasa Shiraki, Sagamihara-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/588,284

(22) Filed: Oct. 9, 2009

(30) Foreign Application Priority Data
Oct. 10, 2008 (JP) 2008-264546

(51) Int. Cl. G06F 3/12; H04N 1/04

(52) U.S. Cl. 358/1.13; 358/498

(57) ABSTRACT

An image forming apparatus includes an image forming unit, an image reading unit disposed above the image forming unit, a sheet discharge space disposed between the image reading unit and the image forming unit, a sheet discharge unit to discharge the sheet into the sheet discharge space from a back side to the front side, an operation unit disposed on the front side and including a display and an instruction input portion, and a document feeder disposed above the image reading unit. The image reading unit includes a document table, a document reverse unit to reverse and transport the original document, and a document discharge portion disposed beneath the document table, to which the original document is discharged. On the front side, the operation unit screens the document reverse unit while exposing both the document table and the document discharge portion of the document feeder from the front side.

### CROSS-REFERENCE TO RELATED APPLICATIONS

This patent specification is based on and claims priority from Japanese Patent Application No. 2008-264546, filed on Oct. 10, 2008 in the Japan Patent Office, which is hereby incorporated by reference herein in its entirety.

### BACKGROUND OF THE INVENTION

1. Field of the Invention

The present invention generally relates to an image forming apparatus such as a copier, a printer, a facsimile machine, a plotter, or a multifunction machine including at least two of those functions.

2. Discussion of the Background Art

In general, image forming apparatuses, such as copiers, printers, facsimile machines, plotters, or multifunction machines including at least two of those functions, etc., include a display or an operation panel with a display via which users input instructions.

To improve visibility and usability of the display and/or the operation panel, several approaches, described below, have been advanced.

For example, certain known image forming apparatuses include an image reading unit that includes an openable document cover disposed on a contact glass, and an operation panel with a relatively large display disposed above the image reading unit outside an area through which the document cover moves. As the display side of the display is on a front side of the image forming apparatus, sufficient visibility and usability of the operation panel can be attained without sacrificing the usability of the image reading unit, visibility of and access to a sheet discharge portion, and the ability to remove sheets of recording media (paper, film, etc.) from the sheet discharge portion.

However, the above-described known image forming apparatuses can be bulky in part because the operation panel is disposed above the image reading unit outside the area through which the document cover moves. In addition, because the operation panel is located on a plane above the surface on which documents are set, it is difficult for uses to access and use the operation panel when the image forming apparatus is placed on a desk or when the user is in a wheel chair.

In another known image forming apparatus, the operation panel is disposed above its main body (e.g., image forming unit). However, although sufficient visibility and usability of the operation panel can be attained with such a configuration, because the operation panel is disposed on a side of the area through which the document cover moves, the operation panel projects to that side from the main body, which makes the image forming apparatus also bulky.

Yet another known image forming apparatus is a housing-internal discharge type that includes the sheet discharge portion inside the housing of the apparatus, which is typically between the image reading unit and the image forming unit. In this known image forming apparatus, sheets are discharged from right to left when users are on the front side thereof, and a front end of the image reading unit is behind a front end of the image forming unit, that is, the depth of the image reading unit from front to back is smaller than that of the image forming unit. The operation panel is disposed in front of the image reading unit and rotatably supported by a housing of the image forming unit at an upstream end portion in the direction in which sheets are discharged, so as not to degrade the visibility of the sheet discharge portion.

However, in this known image forming apparatus, use of a large display means that the display project from the image forming unit in a lateral direction so as not to degrade the visibility of the sheet discharge portion. Thus, the image forming apparatus becomes bulkier. Even when the operation panel is configured to rotate vertically so as not to interfere with the sheet discharge portion, the operation panel can project from the front end of the image forming unit. Thus, the depth of the image forming apparatus from front to back is increased.

In view of the foregoing, there is a need for image forming apparatuses including a large display to be compact as well as to provide sufficient usability, and visibility and removability of the discharged sheets regardless of whether the image forming apparatus is placed on the floor or on a desk, or whether the user is standing or in a wheel chair.

### SUMMARY OF THE INVENTION

In view of the foregoing, one illustrative embodiment of the present invention provides an image forming apparatus that includes an image forming unit to form an image on a sheet of recording media, an image reading unit disposed above the image forming unit, to read image data of an original document transported to a reading position in the image reading unit, a sheet discharge space, a sheet discharge unit, a document feeder, and an operation unit.

The sheet discharge space is defined by the image reading unit and the image forming unit and disposed therebetween, exposed from a front side of the image forming apparatus. The sheet discharge unit discharges the sheet into the sheet discharge space in a sheet discharge direction from a back side to the front side of the image forming apparatus after the image is formed on the sheet. The document feeder is disposed above the image reading unit, feeds the original document to the image reading unit, and includes a document table on which the original document is set, a document reverse unit to reverse and transport the original document to the reading position, and a document discharge portion disposed beneath the document table, to which the document is discharged from the reading position. The operation unit is disposed on the front side of the image forming apparatus and includes a display portion and an instruction input portion. The operation unit screens the document reverse unit of the document feeder from the front side of the image forming apparatus while both the document table and the document discharge portion of the document feeders are exposed from the front side.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a external perspective view illustrating an image forming apparatus according to an illustrative embodiment of the present invention, viewed obliquely from the left, obliquely from above;

FIG. 2 is a vertical cross-sectional view illustrating a configuration of an interior of the image forming apparatus shown in FIG. 1;

FIG. 3 illustrates a cross section of an ADF;

FIG. 4 is an external view illustrating a state in which a user holds a grip of the ADF shown in FIG. 3 to open the ADF with respect to an image reading unit;

FIG. 5 is a side view of the image forming apparatus shown in FIG. 1, viewed from the left in FIG. 1;

FIGS. 6A, 6B, and 6C respectively illustrate relative positions of an operation panel, the ADF, the image reading unit, and a main body of the image forming apparatus;

FIG. 7 is a front view of the image forming apparatus viewed from above obliquely illustrating relative positions of width centers of the main body, the operation panel, and a sheet discharge unit;

FIG. 8 is a vertical cross-sectional view illustrating a configuration of an interior of an image forming apparatus according to another illustrative embodiment;

FIG. 9 is a side view of the image forming apparatus shown in FIG. 8, viewed from the left in FIG. 8;

FIGS. 10A, 10B, and 10C respectively illustrate relative positions of an operation panel, an ADF, an image reading unit, and a main body of the image forming apparatus shown in FIG. 8; and

FIG. 11 is a front view of the image forming apparatus shown in FIG. 9, viewed from above obliquely illustrating relative positions of width centers of the main body, the operation panel, and a sheet discharge unit.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

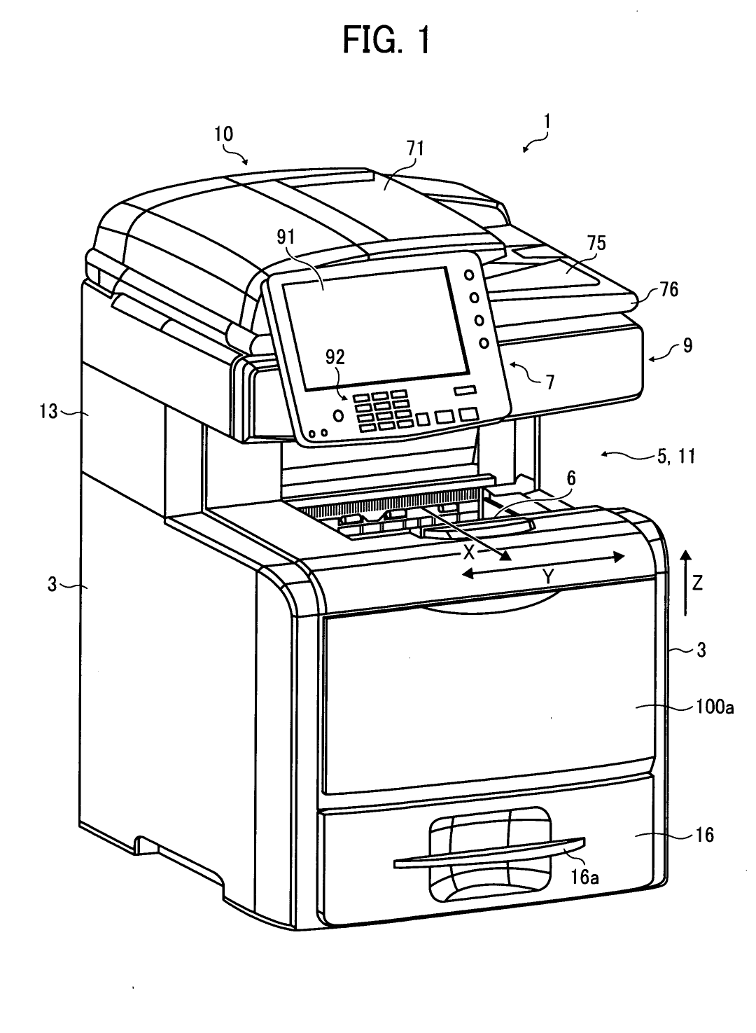

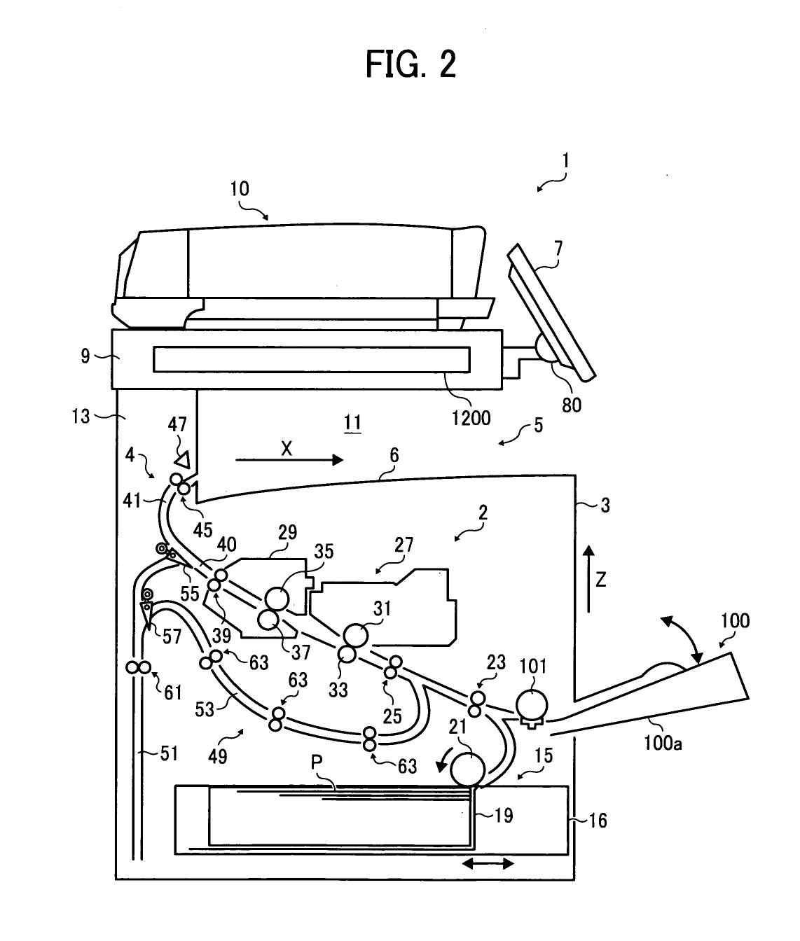

Referring now to the drawings, wherein like reference numerals designate identical or corresponding parts throughout the several views thereof, and particularly to FIGS. 1 and 2, an image forming apparatus according to an illustrative embodiment of the present invention is described.

FIG. 1 is a external perspective view illustrating an image forming apparatus 1 viewed from its front side obliquely, and FIG. 2 is a vertical cross-sectional view illustrating a configuration of an interior of the image forming apparatus 1.

The image forming apparatus 1 shown in FIGS. 1 and 2 is housing-internal discharge type and includes an image forming unit 2 disposed in a center portion in a main body 3, a sheet discharge unit 4 to discharge sheets on which images are formed by the image forming unit 2 from a back side in a direction indicated by arrow X shown in FIGS. 1 and 2 (hereinafter “sheet discharge direction X”), and a housing-internal discharge space 11 that is defined by an upper surface of the main body 3 and a lower surface of an image reading unit 9 and disposed therebetween. The image reading unit 9 is disposed above the main body 3 so that the discharge space 11 is exposed from the front side. That is, the discharge space 11 is exposed on a downstream side in the sheet discharge direction, forming an opening 5 through which the sheets are removed from the discharge space 11. The image forming unit 2 can form images on sheets of recording media such as paper, overhead projector (OHP) film, and the like. The image reading unit 9 is includes a scanning member 1200 and is mounted on a support column 13, serving as a spacer, disposed on the back side of the image forming apparatus 1.

The image forming apparatus 1 further includes an operation unit or operation panel 7 disposed on the front side of the image forming apparatus, and an automatic document feeder (ADF) 10, disposed above the image reading unit 9. The operation panel 7 is rotatably supported by a movable support member 80 and connected to the image reading unit 9 via the support member 80. Using the support member 80, the operation panel 7 can be moved between a vertical position and a horizontal position while moving or sliding in the sheet discharge direction X. The operation panel 7 includes an instruction input portion 92 and a display portion 91 used for image forming operation and operation to read image date of original documents by the image reading unit 9.

The ADF 10 includes a document table 71 on which original documents are set, a discharge table 75 on which the original documents are discharged, and a grip 76. It is to be noted that hereinafter the support member 80 supporting the operation panel 7 is omitted in the drawing for simplicity.

The upper surface of the main body 3 forms a sheet stack part 6 serving as a first sheet stack part. The sheets discharged on the sheet stack part 6 can be easily removed through the opening 5 provided on the front side, which is also referred to as “operation panel side”.

The image forming apparatus 1 further includes a manual feed tray 100 hinged on the front side of the main body 3 rotatably, and a sheet cassette 16 that is disposed in its lower portion and includes a grip 16a.

The manual feed tray 100 can be lifted from the state shown in FIG. 2 to be closed with respect to the main body 3 as shown in FIG. 1. When the manual feed tray 100 is closed, a back side thereof serves as an exterior cover 100a.

It is to be noted that, in the drawings, reference characters Y represents a sheet width direction perpendicular to the sheet discharge direction X, and Z represents a vertical direction perpendicular to the sheet discharge direction X.

Referring to FIG. 2, a configuration inside the main body 3 is described below.

A feed roller 101 is disposed on a downstream side of the manual feed tray 100 in a direction in which sheets set on the manual feed tray 100 are fed to the image forming unit 2. Inside the main body 3, a sheet feeder 15 including the sheet cassette 16 is provided in a lower portion, and an image forming device 27 and a fixing device 29 are provided in an upper portion. The sheet cassette 16 includes a container 19 that can contain multiple sheets P and is detachably insertable into the main body 3. Users can insert the sheet cassette 16 into the main body 3 and draw out the sheet cassette 16 by gripping the grip 16a shown in FIG. 1. The sheet feeder 15 further includes a feed roller 21 that rotates in a direction indicated by an arrow shown in FIG. 2 to feed the sheet P toward a pair of transport rollers 23. A pair of registration rollers 25 to adjust the skew of the sheet P and to forward the sheet P to the image forming device 27 is provided downstream from the transport rollers 23 in a direction in which the sheet is transported (hereinafter “sheet transport direction”).

It is to be noted that, although the description above concerns the configuration using a single sheet cassette 16, additional sheet cassettes can be installed in the image forming apparatus 1 upon request from the user. When one or more additional sheet cassettes are installed in the image forming apparatus 1, the height, that is, the length in the vertical direction Z, of the main body 3 increases accordingly.

The image forming device 27 includes a photoreceptor drum 31 serving as an image carrier, a transfer roller 33, serving as a transfer member, disposed facing the photoreceptor drum 31, and the like.

Although not shown, a charging member, an exposure member, a developing device, a cleaning member, a discharge member, and the like are provided around the photoreceptor drum 31 to form an image on the photoreceptor drum 31 through a known electrophotographic image forming process. While the photoreceptor drum 31 rotates, initially an electrostatic latent image is formed on the photoreceptor drum 31, and then the latent image is developed with toner into a toner image.

While the toner image is thus formed on the photoreceptor drum 31, the sheet P is fed from either the sheet cassette 16 or the manual feed tray 100 along a first transport path 40. Then, the pair of registration rollers 25 forwards the sheet P to a transfer nip where the transfer roller 33 presses against the photoreceptor drum 31, timed to coincide with the toner image formed on the photoreceptor drum 31. In the transfer nip, the transfer roller 33 transfers the toner image electrostatically from the photoreceptor drum 31 onto the sheet P.

The fixing device 29 includes a fixing roller 35, a pressure roller 37 pressing against the fixing roller 35, and the like. The fixing device 29 heats and fuses the toner image on the sheet P and thus fixes it thereon, after which a pair of rollers 39 discharges the sheet P downstream along the first transport path 40.

The sheet discharge unit 4 is disposed downstream from the fixing device 29 in the sheet transport direction. The sheet discharge unit 4 includes a first discharge path 41. A pair of first discharge rollers 45 and a sheet detector 47 are provided at a downstream end of the first discharge path 41. In the sheet discharge unit 4, the sheet P is transported along the first discharge path 41 and then discharged onto the sheet stack part 6 with its image surface faced down.

The image forming apparatus 1 further includes a reverse unit 49 disposed between the sheet feeder 15 and the image forming device 27 to reverse the sheet P when images are formed on both sides thereof.

The reverse unit 49 includes a reverse path 51 that branches off from the first transport path 40, and a resending path 53 that branches off from an upper portion of the reverse path 51 and merges with the first transport path 40 upstream from the registration rollers 25 in the sheet transport direction. A separation pawl 55 is provided at a branch point between the first transport path 40 and the reverse path 51, and another separation pawl 57 is provided at a branch point between the reverse path 51 and the resending path 53.

In a duplex printing mode, after an image is formed on its front side or first side, the sheet P is guided to the reverse path 51 by the separation pawl 55, after which a pair of transport rollers 61 transports the sheet P downward in FIG. 2 for a predetermined or given distance. A leading edge and a trailing edge of the sheet P in this state are respectively referred to as a first end and a second end. In the reverse path 51, the sheet P is held substantially vertically with the first end down and the second end up. Subsequently, the sheet P is guided by the separation pawl 57 to the resending path 53 from the second end.

Then, while transported along the resending path 53 by multiple pairs of transport rollers 63, the sheet P is reversed and then forwarded again to the transfer nip in the image forming device 27.

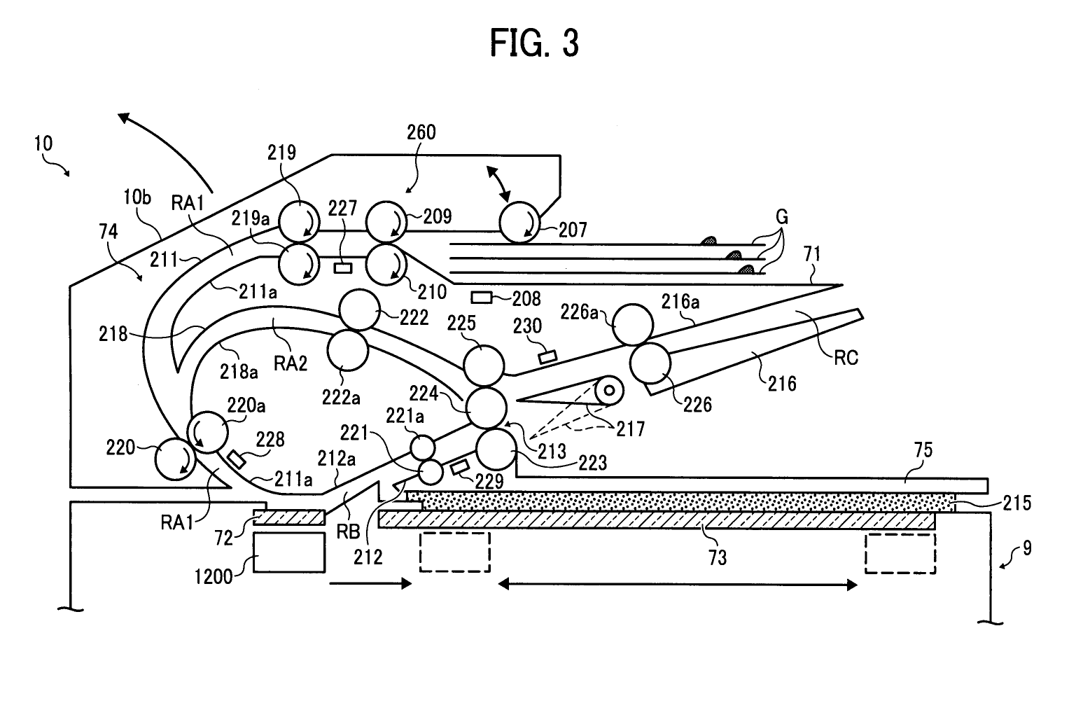

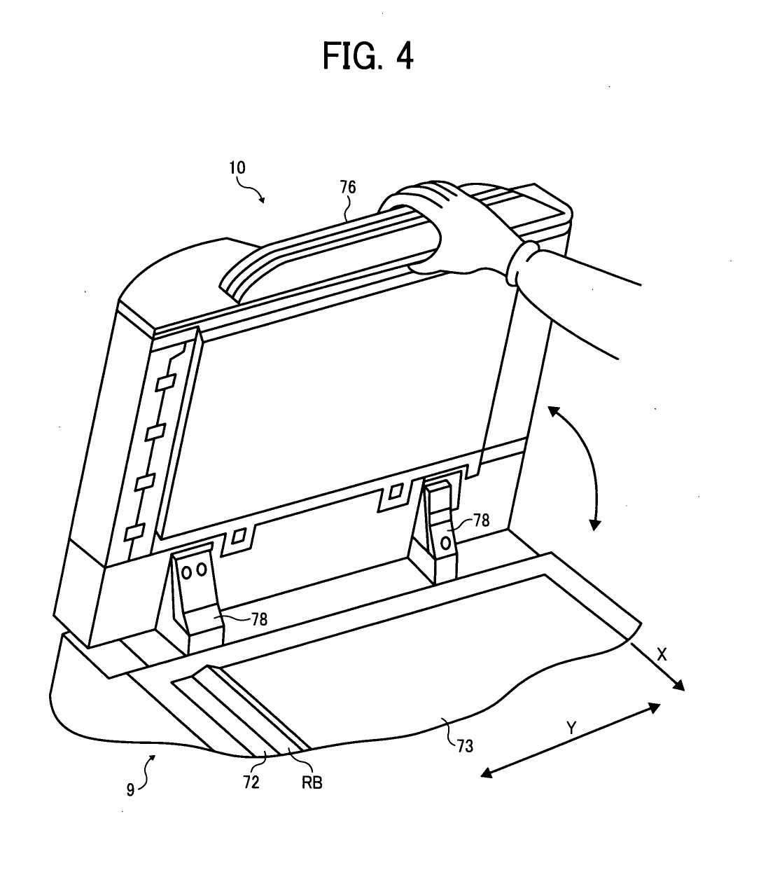

Next, the image reading unit 9 as well as the ADF 10 disposed above the image reading unit 9 are described below with reference to FIGS. 3 and 4. FIG. 3 illustrates a cross section of the ADF 10, and FIG. 4 illustrates an exterior of the ADF 10 that is rotatably hinged to the image reading unit 9.

As shown in FIG. 3, the ADF 10 further includes a document reverse unit 74 to reverse a document G set on the document table 71 and send it onto a slit glass 72, serving as a first reading position, provided on an upper surface of the image reading unit 9. After its image date is read, the document G is discharged onto the discharge table 75 disposed beneath the document table 71.

On the upper surface of the image reading unit 9, a contact glass 73 is provided in addition to the slit glass 72, beneath which the image reading member 1200 is disposed. When the document G is sent by the ADF 10, the image reading member 1200 moves to beneath the slit glass 72 and reads the document G while the document G is moving. By contrast, when the document G is set on the contact glass 73, the image reading member 1200 moves to positions indicated by dotted squares shown in FIG. 3 and reads the document G while moving from side to side.

Additionally, reading modes (e.g., a single-side reading mode and a duplex reading mode) can be selected via the operation panel 7 shown in FIG. 1, and the operation of the image reading unit 9 is controlled according to the selected mode.

A more specific configuration and operation of the ADF 10 are described below.

In the configuration shown in FIG. 3, documents G are arranged in the order of pages and set on the document table 71 with their image surfaces faced down. A feed roller 207 to forward the documents G to a separation point 260 is initially at a standby position that is at a given distance from the document table 71. When a sensor 208 detects that a document G is present on the document table 71 and the start of document feeding is instructed, the feed roller 207 descends from the standby position to contact an upper side of the document G.

A feed roller 209, disposed downstream form the feed roller 207 in a direction in which the document G is transported (hereinafter “document transport direction”), rotates clockwise in FIG. 3 and a separation roller 210 is disposed facing the feed roller 209. By rotating the separation roller 210 clockwise in FIG. 3 or keeping the separation roller 210 from rotating, only a single document G on the top of the multiple documents sandwiched between the feed roller 209 and the separation roller 210 can be separated with the friction effects between the two rollers. Thus, the feed roller 209 and the separation roller 210 together form a separation unit to separate the multiple documents one by one. The document G is then forwarded to an arched first document path RA1 provided between the separation unit and the slit glass 72.

The feed rollers 207 and 209 are connected to a stepping motor, not shown, that serves as a driving member via a driving transmission member, not shown, such as a timing belt, a timing pulley, or a line of gears.

The first document path RA1 is formed between guide members 211 and 211a to guide the document G onto the slit glass 72. The document G is reversed through the first document path RA1 and transported onto the slit glass 72 with its image surface faced down. The document reverse unit 74 includes transport rollers 219; 219a, 220, and 220a disposed along the first document path RA1.

Additionally, a document discharge path RB is formed between guide members 212 and 212a to transport the document G on the slit glass 72 to a discharge port 213. The document G is transported by rollers 221 and 221a and then discharged by rollers 213 and 214 through the discharge, port 213, after which the document G is stacked on the discharge table 75 disposed above the contact glass 73. A pressure member 215 formed of an elastic material such as sponge or rubber is provided beneath the discharge table 75, on a surface facing the contact glass 73. The pressure member 215 holds the document G set on the contact glass 73.

Guide members 216 and 216a and a switch pawl 217 are provided in a lower portion of the document table 71 and together form a switchback path RC. Rollers 226 and 226a that can rotate both in a normal direction and the reverse direction are provided along the switchback path RC. When the both side of the document G are read, after discharged from the discharge port 213, the document G is transported to the switchback path RC, sent back along the switchback path RC, and then again sent to the first document path RA1.

The switch pawl 217 is disposed above the discharge table 75 and movable between a first position indicated by solid lines and a second position indicated by dashed lines shown in FIG. 3. The switch pawl 217 moves to the second position indicated by dashed lines to guide the document G discharged from the discharge port 213 to the switchback path RC, and the rollers 226 and 226a rotate in the normal direction to transport the document G along the switchback path RC. After a trailing edge of the document G enters the switchback path RC, the switch pawl 217 moves to the first position indicated by solid lines. The rollers 226 and 226a rotate in reverse, thus sending back the document G along the switchback path RC, and then the switch pawl 217 guides the document G to a second document path RA2 from the trailing edge. Then, the roller 224 and a roller 225 facing each other transport the document G into the second document path RA2.

The second document path RA2 is formed between guide members 218 and 218a and merges with the first document path RA1 upstream from the slit glass 72 in the document transport direction. The document G is transported by rollers 222 and 222a along the second document path RA2.

The ADF 10 further includes sensors 227, 228, 229, and 230 that are reflection-type photosensors to detect the leading edge or trailing edge of the document G passing thereby. The sensors 227, 228, 229, and 230 are respectively disposed at an entrance portion of the first document path RA1, at an exit portion of the first document path RA1, at a portion between the rollers 221 and 221a and the rollers 223 and 224 along the discharge path RB, and a portion between the rollers 224 and 225 and the rollers 226 and 226a along the switchback path RC.

Additionally, a cover 10a of the ADF 10 can rotate together with the guide member 211 in a direction indicated by an arrow shown in FIG. 3. When the cover 10a is thus lifted, the first document path RA1 can be exposed to facilitate removal of documents jammed therein.

As shown in FIG. 4, the ADF 10 is connected to the image reading unit 9 with a hinge 78 so as to be openable and closable with respect to the upper surface (e.g., contact glass 73) of the image reading unit 9. The grip 76 is disposed shifted to the right from a center portion on the front side of the ADF 10 in FIG. 4, and users can conveniently open and close the ADF 10 by holding the grip 76.

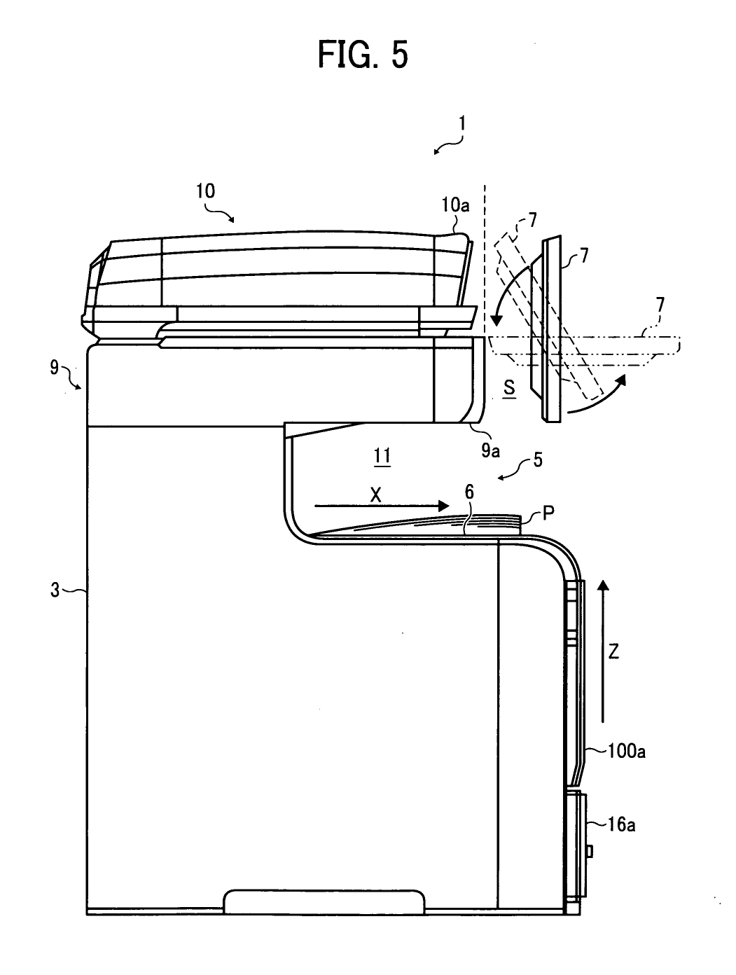

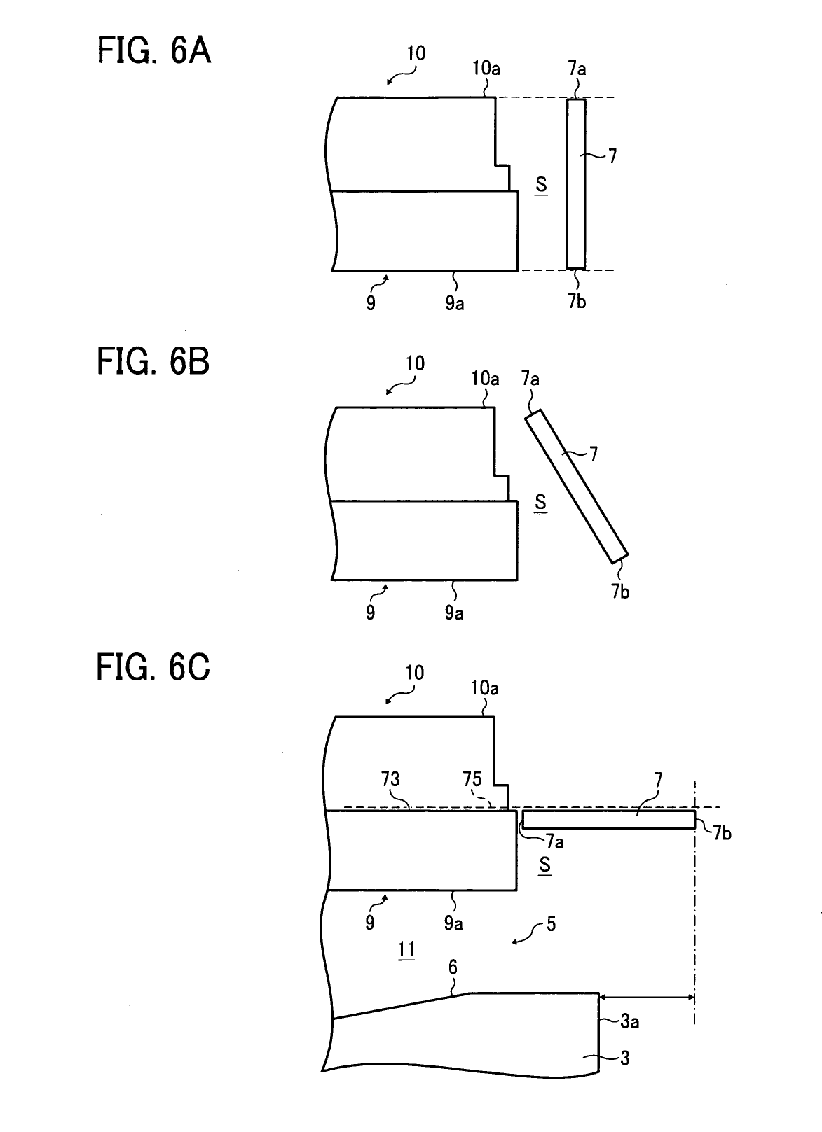

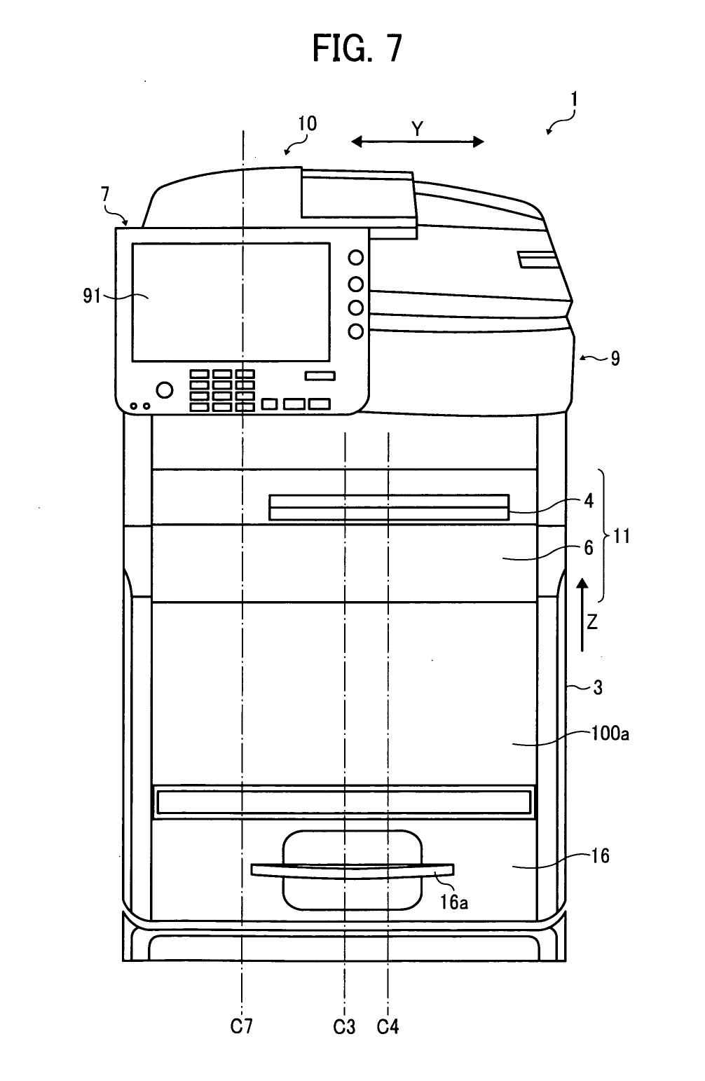

Next, the operation panel 7 is described below with reference to FIGS. 5 to 7. FIG. 5 is a side view of the image forming apparatus 1 from the left in FIG. 1, FIGS. 6A, 6B, and 6C respectively illustrate relative positions of the operation panel 7 in the image forming apparatus 1, and FIG. 7 is a front view of the image forming apparatus viewed from above obliquely.

The operation panel 7 includes the display portion 91 that in the present embodiment is an LC (liquid crystal) display, various LEDs (Light-Emitting Diodes), and the instruction input portion 92 (also “hard key 92”) including numeric keys, a start key, and the like. The operation panel 7 is disposed on the front side of the image reading unit 9 with its operation side (e.g., front side or display side) faced on the front side to provide good visibility and operability.

The display portion 91 includes a touch panel with which the user can select one of mode select keys for copying, scanning, fax transmission, image formation according to image data transmitted from a computer communicably connected to the image forming apparatus 1, or the like.

Although conventional operation panels are typically relatively long in the sheet width direction Y because the hard key is disposed on the side of the display, the operation panel 7 in the present embodiment is shorter in the sheet width direction Y and longer in the vertical direction Z because the hard key 92 is disposed beneath the display portion 91.

As shown in FIG. 1, in a lateral direction, that is, the sheet width direction Y, the operation panel 7 is disposed within the width of the main body 3, on the side where the document reverse unit 74 shown in FIG. 3 is disposed, that is, opposite the side where the document table 71 and the discharge table 75 are disposed.

Thus, a feature of the present embodiment is that the operation panel 7 is disposed to screen the document reverse unit 74 from the front side of the main body 3 while the document table 71 as well as the discharge table 75 are exposed, and that a lower end 7b (shown in FIG. 6A) of the operation panel 7 is not lower than a lower end 9a (shown in FIG. 6A) of the image reading unit 9.

Therefore, in the present embodiment, good visibility and operability of the operation panel 7 can be attained because the operation side (e.g., front side) of the operation panel 7 is disposed on the front side. Simultaneously, setting the original document on the document table 71 can be easy and good visibility of the original document discharged on the discharge table 75 can be attained because the document table 71 and the discharge table 75 are exposed from the front side, not screened by the operation panel 7.

Additionally, as shown in FIGS. 1 and 4, the grip 76 of the ADF 10 is partly exposed. That is, the grip 76 is closer to the right opposite the side on which the operation panel 7 is disposed, when viewed from the front side. Therefore, the users can easily hold the grip 76 and thus lift and lower the ADF 10 easily.

Moreover, because the sheet stack part 6 in the main body 3 can be exposed, good visibility as well as good removability of the sheets discharged on the sheet stack part 6 can be attained.

Thus, in the configuration described above, while the image forming apparatus 1 can be relatively compact by disposing the operation panel 7 within the area of the ADF 10, visibility and operability of the operation panel 7 for the users in wheelchairs or chairs can be good even when the image forming apparatus 1 is placed on a desk, or when the image forming apparatus 1 is placed on the floor with an additional tray attached beneath the main body 3.

Referring to FIGS. 5 through 6C, positions of the operation panel 7 are described below.

FIG. 5 illustrates that the operation panel 7 can rotate vertically among a vertical position (e.g., standing state) indicated by solid lines, an oblique position indicated by dashed lines, and a horizontal position indicated by double-dashed lines. FIGS. 6A, 6B, and 6C respectively illustrate the vertical position, the oblique position, and the horizontal position shown in FIG. 5.

The image reading unit 9 and the ADF 10 are disposed backward from the operation panel 7 across a space S. When the operation panel 7 is at the vertical position, that is, is standing vertically, the display side of the operation panel 7 is backward from the front side of the main body 3, and thus the image forming apparatus 1 can be relatively compact.

In this state, as shown in FIG. 6A, an upper end 7a of the operation panel 7 is disposed at a height similar to that of an upper end 10a of the ADF 10 while the lower end 7b of the operation panel 7 is disposed at a height similar to that of the lower end 9a of the image reading unit 9 in the vertical direction Z. In other words, the upper end 7a of the operation panel 7 is not higher than the upper end 10a of the ADF, and the lower end 7b of the operation panel 7 is not lower than the lower end 9a of the image reading unit 9 in the vertical direction Z. Alternatively, the lower end 7b of the operation panel 7 may be lower than the lower end 9a of the image reading unit 9 as long as the lower end 7b does not contact the sheets P discharged from the sheet discharge unit 4 onto the sheet stack part 6.

From the vertical position shown in FIG. 6A, the operation panel 7 can be rotated to the oblique position shown in FIG. 6B while moving or sliding in the sheet discharge direction X. Similarly to the state shown in FIG. 6A, also when the operation panel 7 is at the oblique position shown in FIG. 6B, the upper end 7a of the operation panel 7 is not higher than the upper end 10a of the ADF 10, and the lower end 7b of the operation panel 7 is not lower than the lower end 9a of the image reading unit 9 in the vertical direction Z. To enable the operation panel 7 to rotate to the horizontal position, the operation panel 7 should be disposed so that the upper end 7a does not contact any portion of the ADF 10 at any oblique position.

Referring to FIG. 6C, the operation panel 7 should be disposed so that the document set on the contact glass 73 does not interfere with the operation panel 7 at the horizontal position even when a larger document is set on the contact glass 3. In other words, the operation panel 7 at the horizontal position should be lower than the contact glass 73 (upper surface of the image reading unit 9). In this state, the lower end 7a of the operation panel 7 projects in the sheet discharge direction X shown in FIG. 5 from the front surface 3a of the main body 3.

The operation panel 7 can be set to a given position between the vertical position and the horizontal position or moved among multiple positions. Thus, the position of the operation panel 7 can be set according to user's needs.

When the operation panel 7 at the horizontal position shown in FIG. 6C is lower than the upper surface of the image reading unit 9, the image reading unit 9 can read larger documents such as maps.

It is to be noted that the operation panel 7 is constantly on the front side of the image reading unit 9 and does not interfere with the ADF 10 nor the image reading unit 9 while rotating between the vertical position and the horizontal position, that is, at any given rotation angle.

The movable support member 80 shown in FIG. 2 supporting the operation panel 7 can lay flat the operation panel 7 from the standing state, that is, change the rotation angle of the operation panel 7 between 0 degree to 90 degrees, while moving or sliding the operation panel 7 in the sheet discharge direction X. A four-link mechanism can be used for the movable support member 80.

FIG. 7 illustrates relative positions of the main body 3, the sheet discharge unit 4, and the operation panel 7 in the sheet width direction Y. Reference characters C3 represents a center (hereinafter “width center C3”) of the main unit 3, C4 represents a center (hereinafter “width center C4”) of the sheet discharge unit 4 (e.g., sheet discharge port), and C4 represents a center (hereinafter “width center C7”) of the operation panel 7 in the sheet width direction Y.

It is to be noted that, although the sheet discharge unit 4 is lower than the sheet stack part 6 as shown in FIG. 1 and thus is not visible in a front elevation view, it is assumed that FIG. 7 illustrates image forming apparatus 1 viewed from above obliquely to schematically illustrate the position of the sheet discharge unit 4.

Referring to FIG. 7, in the present embodiment, the width center C7 of the operation panel 7 and the width center C4 of the sheet discharge unit 4 sandwich the width center C3 of the main body 3 therebetween. In other words, the width center C7 of the operation panel 7 and the width center C4 of the sheet discharge unit 4 are on the opposite sides of the width center C3 of the main body 3.

Herein, the present embodiment adopts a center alignment sheet discharge, that is, respective centers in the sheet width direction of different sized sheets are aligned with the width center C4 of the sheet discharge unit 4.

As described above, in a lateral direction in FIG. 7, the width center C4 of the sheet discharge unit 4, that is, a center portion of the sheet stack part 6 in the housing-internal discharge space 11, is shifted to the side from the width center C3 of the main body 3, and the width center C7 of the operation panel 7 is shifted from the width center C3 of the main body 3 to the side opposite the side to which the width center C4 is shifted.

Therefore, at whichever rotation angle the operation panel 7 is, the sheet stack part 6 can be exposed in the front view of the main body 3, providing sufficient visibility and easy removal of the sheets P discharged onto the sheet stack part 6. In the present embodiment, at least half the sheet stack part 6 in the sheet width direction Y is exposed, and better visibility and removability of the sheets P can be achieved.

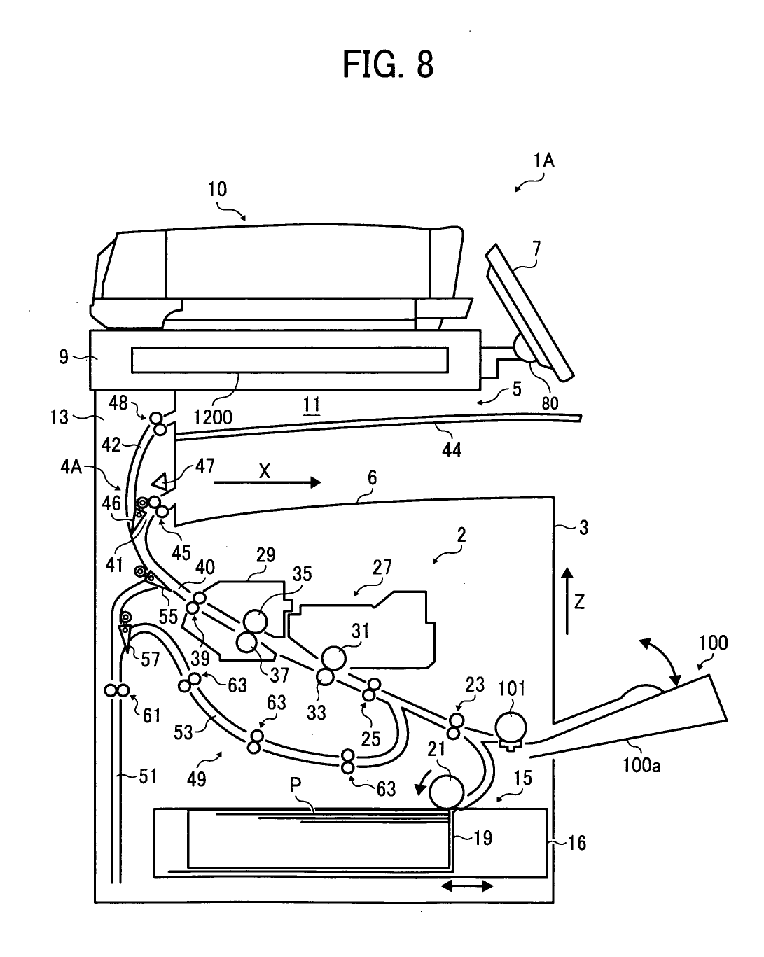

Another embodiment is described below with reference to FIGS. 8 through 11.

An image forming apparatus 1A shown in FIGS. 8 through 11 is different from the embodiment shown in FIGS. 1 through 7 in that an additional tray 44 is used as a second sheet stack part disposed between the sheet stack part 6 and the image reading unit 9 to receive the sheets discharged from the main body 3. Accordingly, the position of the operation panel 7 is changed from that of the embodiment shown in FIGS. 1 through 7. Except for these points, the image forming apparatus 1A has a configuration similar to that of the image forming apparatus 1 shown in FIGS. 1 through 7, and thus descriptions thereof omitted.

As shown in FIG. 8, a sheet discharge unit 4A disposed downstream from the first transport path 40 in the sheet discharge direction includes a second discharge path 42 in addition to the first discharge path 41 that branches from the first transport path 40 and leads to the sheet stack part 6. The second discharge path 42 branches from the first discharge path 41 and leads to the additional tray 44, and a separation pawl 46 is provided at a separation point between the first discharge path 41 and the second discharge path 42.

For example, according to signals from a facsimile machine, not shown, the image forming unit 2 forms an image on a sheet P through a process similar to that in the embodiment shown in FIGS. 1 through 7, and then the sheet P is guided by the separation pawls 55 and 46 to the second discharge path 42. A pair of second discharge rollers 48 is provided in a downstream end portion of the second discharge path 42 in the sheet discharge direction. The second discharge rollers 48 discharge the sheet P onto the additional tray 44 with the image surface faced down.

As shown in FIGS. 8 through 10, a front end of the additional tray 44 projects from a front end of the image reading unit 9 to the right in FIGS. 8 through 10C, and the operation panel 7 is disposed above the portion of the additional tray 44 projecting from the front end of the image reading unit 9.

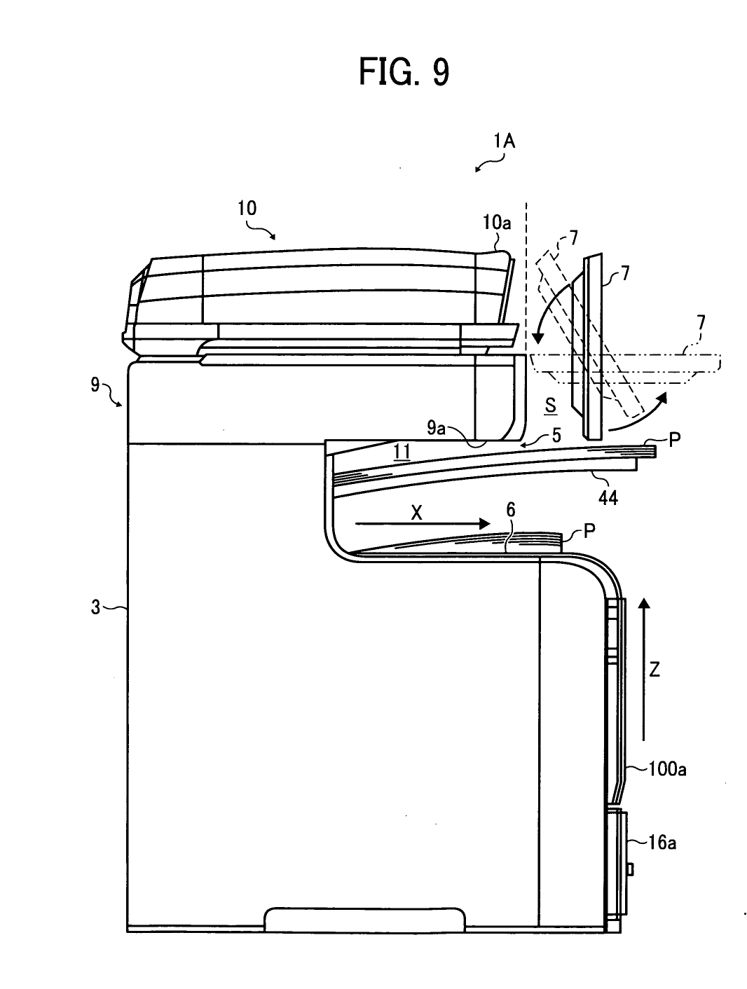

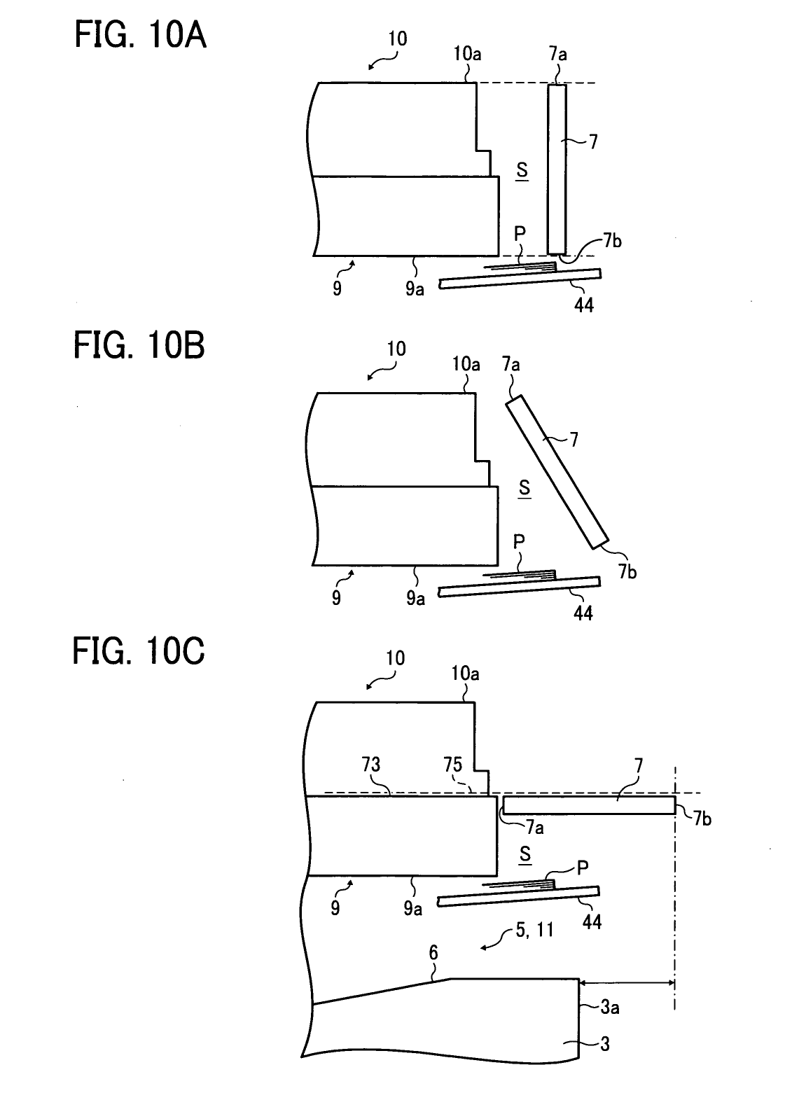

Referring to FIGS. 9 through 10C, positions of the operation panel 7 are described below with a focus on differences from the embodiment shown in FIGS. 1 through 7. FIG. 9 is a side view of the image forming apparatus 1A viewed from the left in FIG. 8 and illustrates that the operation panel 7 can rotate vertically among the vertical position indicated by solid lines, the oblique position indicated by dashed lines, and the horizontal position indicated by double-dashed lines. FIGS. 10A, 10B, and 10C respectively illustrate the vertical position, the oblique position, and the horizontal position shown in FIG. 9.

In the vertical state shown in FIG. 10A, the height of the upper end 7a of the operation panel 7 is similar to that of the upper end 10a of the ADF 10 while the height of the lower end 7b of the operation panel 7 is similar to that of the lower end 9a of the image reading unit 9 in the vertical direction Z. In other words, the upper end 7a is not higher than the upper end 10a, and the lower end 7b is not lower than the lower end 9a in the vertical direction Z. Alternatively, the lower end 7b of the operation panel 7 may be lower than the lower end 9a of the image reading unit 9 as long as the lower end 7b does not contact the sheets P discharged on the additional tray 44.

The relative positions of the operation panel 7 in the image forming apparatus 1A shown in FIGS. 10B and 10C are similar to those shown in FIGS. 6B and 6C, and thus descriptions thereof omitted.

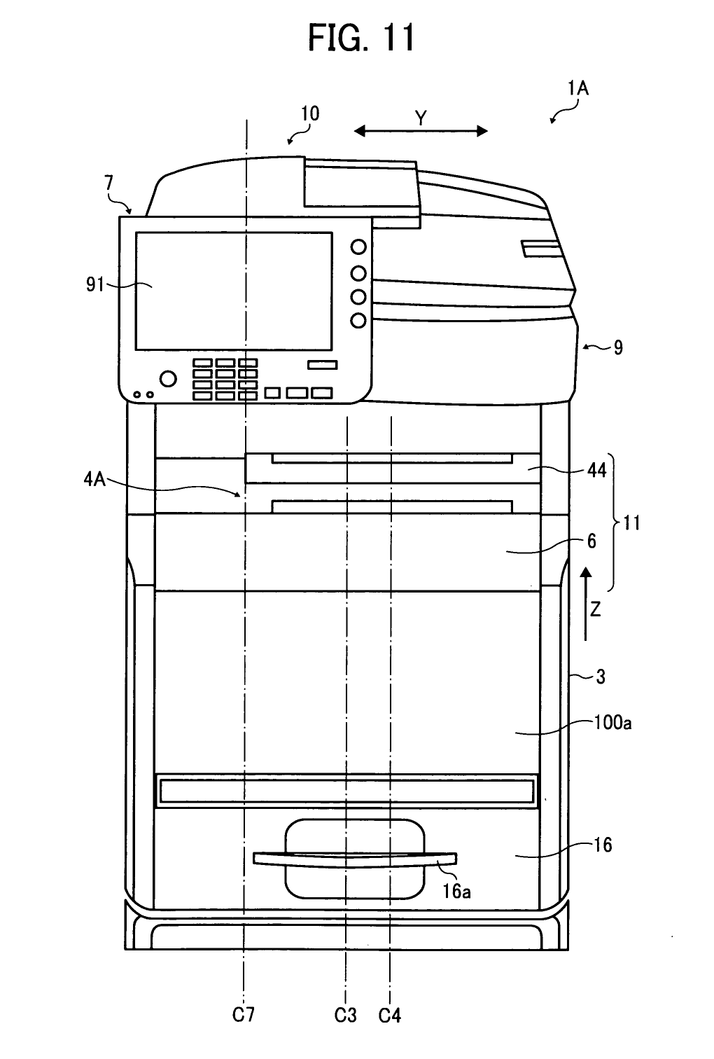

FIG. 11 illustrates relative positions of the main body 3, the sheet discharge unit 4A, and the operation panel 7 in the sheet width direction Y. It is to be noted that it is assumed that FIG. 11 illustrates image forming apparatus 1A obliquely from above to schematically illustrate the position of the sheet discharge unit 4A similarly to FIG. 7.

Referring to FIG. 11, also in the present embodiment, the operation panel 7 is disposed so that the width center C7 of the operation panel 7 and the width center C4 of the sheet discharge unit 4A sandwich the width center C3 of the main body 3 therebetween. In other words, the width center C7 of the operation panel 7 and the width center C4 of the sheet discharge unit 4A are on the opposite sides of the width center C3 of the main body 3. It is to be noted that, in the present embodiment, the width center C4 is identical or similar to a width center of the additional tray 44.

Therefore, at whichever rotation angle the operation panel 7 is, the opening 5 of the housing-internal discharge space 11 can be exposed in the front view of the main body 3, attaining sufficient visibility and easy removal of the sheets P discharged on either the sheet stack part 6 or the additional tray 44. In the present embodiment, at least half the additional tray 44 as well as the sheet stack part 6 in the sheet width direction Y is exposed, and thus better visibility and removability of the sheets P can be achieved.

It is to be noted that the operation unit 7 is not limited to the configuration described above and may include an audio announcement member such as a buzzer or a speaker, and the like.

The present embodiment is not limited to the image forming apparatuses described above but can be applied to any image forming apparatuses that include an image forming unit, an image reading unit disposed above the image forming unit, a housing-internal sheet discharge space disposed between the image reading unit and the image forming unit and exposed from the front side, a sheet discharge unit to discharge sheets from a back side to the front side of the image forming apparatus, a document feeder disposed above the image reading unit, and an operation unit disposed on the front side and including a display portion and an instruction input portion required for operations to read original documents and for forming images on the sheets.

Numerous additional modifications and variations are possible in light of the above teachings. It is therefore to be understood that, within the scope of the appended claims, the disclosure of this patent specification may be practiced otherwise than as specifically described herein.

What is claimed is:

1. An image forming apparatus, comprising:
an image forming unit to form an image on a sheet of recording media;
an image reading unit disposed above the image forming unit, to read image data of an original document transported to a reading position in the image reading unit;
a sheet discharge space defined by the image reading unit and the image forming unit and disposed therebetween, exposed from a front side of the image forming apparatus;
a sheet discharge unit to discharge the sheet into the sheet discharge space in a sheet discharge direction from a back side to the front side of the image forming apparatus after the image is formed on the sheet;
a document feeder disposed above the image reading unit, to feed the original document to the image reading unit, the document feeder including a document table on which the original document is set, a document reverse unit to reverse and transport the original document to the reading position, and a document discharge portion disposed beneath the document table, to which the document is discharged from the reading position; and
an operation unit disposed on the front side of the image forming apparatus and including a display portion and an instruction input portion,
the operation unit screening the document reverse unit from the front side of the image forming apparatus while exposing both the document table and the document discharge portion from the front side of the image forming apparatus.

2. The image forming apparatus according to claim 1, wherein a lower end of the operation unit is not lower than a lower end of the image reading unit.

3. The image forming apparatus according to claim 2, wherein the operation unit is disposed so that, in a sheet width direction perpendicular to the sheet discharge direction, a center portion of the operation unit and a center portion of the sheet discharge unit sandwich therebetween a center portion of a main body of the image forming apparatus.

4. The image forming apparatus according to claim 3, wherein the document table and the document discharge portion of the document feeder are disposed on the right when viewed from the front side,
an upper end of the operation unit is disposed at about the same height as an upper end of the document feeder, and
the lower end of the operation unit is disposed at about the same height as the lower end of the image reading unit.

5. The image forming apparatus according to claim 3, wherein the document feeder comprises a grip with which the document feeder is closably openable with respect to the image reading unit, and
the grip of the document feeder is exposed from the operation unit on the front side at least partly.

6. The image forming apparatus according to claim 2, wherein the document table and the document discharge portion of the document feeder are disposed on the right when viewed from the front side,
an upper end of the operation unit is disposed at about the same height as an upper end of the document feeder, and
the lower end of the operation unit is disposed at about the same height as the lower end of the image reading unit.

7. The image forming apparatus according to claim 2, wherein the operation unit is rotatable vertically between a vertical position and a horizontal position,
a front end of the image reading unit is disposed upstream from a front end of a main body of the image forming apparatus in the sheet discharge direction, and
with the operation unit positioned at the vertical position, the operation unit is disposed upstream from the front end of the main body in the sheet discharge direction.

8. The image forming apparatus according to claim 2, wherein the operation unit is rotatable vertically between a vertical position and a horizontal position, and
an upper end of the operation unit is not higher than an upper end of the image reading unit with the operation unit positioned at the horizontal position.

9. The image forming apparatus according to claim 2, wherein, in a sheet width direction, the operation unit does not project from a main body of the image forming apparatus on a side opposite a side on which the document discharge portion is disposed.

10. The image forming apparatus according to claim 2, further comprising:
a first sheet stack portion to receive the sheet discharged from the sheet discharge unit, disposed above the image forming unit; and
a second sheet stack portion to receive the sheet discharged from the sheet discharge unit, disposed between the first sheet stack portion and the image forming unit,
wherein a front end portion of the second sheet stack portion projects from a front end of the image reading unit, and the operation unit is disposed above the front end portion of the second sheet stack portion projecting from the front end of the image reading unit.

11. The image forming apparatus according to claim 2, wherein the document feeder comprises a grip with which the document feeder is closably openable with respect to the image reading unit, and
the grip of the document feeder is at least partly exposed from the operation unit on the front side.

12. The image forming apparatus according to claim 11, wherein the document table and the document discharge portion of the document feeder are disposed on the right when viewed from the front side of the image forming apparatus,
an upper end of the operation unit is disposed at about the same height as an upper end of the document feeder, and
the lower end of the operation unit is disposed at about the same height as the lower end of the image reading unit.

13. The image forming apparatus according to claim 11, wherein the operation unit is rotatable vertically between a vertical position and a horizontal position,
a front end of the image reading unit is disposed upstream from a front end of a main body of the image forming apparatus in the sheet discharge direction, and
the operation unit is disposed upstream from the front end of the main body in the sheet discharge direction with the operation unit positioned at the vertical position.

14. The image forming apparatus according to claim 11, wherein the operation unit is rotatable vertically between a vertical position and a horizontal position, and
an upper end of the operation unit is not higher than an upper end of the image reading unit with the operation unit positioned at the horizontal position.

15. The image forming apparatus according to claim 11, further comprising:
a first sheet stack portion to receive the sheet discharged from the sheet discharge unit, disposed above the image forming unit; and
a second sheet stack portion to receive the sheet discharged from the sheet discharge unit, disposed between the first sheet stack portion and the image forming unit,
wherein a front end portion of the second sheet stack portion projects from a front end of the image reading unit, and the operation unit is disposed above the front end portion of the second sheet stack portion projecting from the front end of the image reading unit.

16. The image forming apparatus according to claim 1, wherein a lower end of the operation unit is disposed at a position lower than a lower end of the image reading unit so as not to contact the sheet discharged from the sheet discharge unit.

17. The image forming apparatus according to claim 16, wherein, in a sheet width direction, the operation unit does not project from a main body of the image forming apparatus on a side opposite a side on which the document discharge portion is disposed.

18. The image forming apparatus according to claim 1, wherein, in a sheet width direction, the operation unit does not project from a main body of the image forming apparatus on a side opposite a side on which the document discharge portion is disposed.
